(19) United States
(12) Patent Application Publication
(10) Pub. No.: US 2025/0026031 A1
(43) Pub. Date: Jan. 23, 2025

(54) DEPLOYABLE HIGH-RIGIDITY ROBOT ARM IN FOLDING AND ROLLING STORAGE TYPE AND MOBILE ROBOT INCLUDING SAME

(71) Applicant: SEOUL NATIONAL UNIVERSITY R&DB FOUNDATION, Seoul (KR)

(72) Inventors: Kyu Jin CHO, Seoul (KR); Sun-Pill JUNG, Seoul (KR); Jae Young SONG, Ulsan (KR)

(73) Assignee: SEOUL NATIONAL UNIVERSITY R&DB FOUNDATION, Seoul (KR)

(21) Appl. No.: 18/751,766

(22) Filed: Jun. 24, 2024

Related U.S. Application Data
(63) Continuation of application No. PCT/KR2024/002895, filed on Mar. 6, 2024.

(30) Foreign Application Priority Data
May 9, 2023 (KR) 10-2023-0060047

(51) Int. Cl. B25J 18/02; B25J 18/04

(52) U.S. Cl. CPC B25J 18/025; B25J 18/04

(57) ABSTRACT

Proposed is a deployable high-rigidity robot arm in a folding and rolling type. the deployable high-rigidity robot arm includes a hub capable of being rotated forward or backward, a plurality of panels having a sliding and folding structure that is capable of being wound or unwound on the hub, a shape-forming apparatus coupled to the plurality of panels and configured such that the plurality of panels is unwound from the hub and a bent structure is formed, and a shape-maintaining apparatus configured to maintain and extend the bent structure formed by the shape-forming apparatus. Furthermore, the plurality of panels is configured to be telescoped by a rotation of the hub while the plurality of panels maintains the bent structure.

### CROSS-REFERENCE TO RELATED APPLICATIONS

This application is a continuation of International Application No. PCT/KR2024/002895 filed on Mar. 6, 2024, which claims priority to Korean Application No. 10-2023-0060047 filed on May 9, 2023, the entire contents of which are herein incorporated by reference.

### TECHNICAL FIELD

The present disclosure relates to a deployable high-rigidity robot arm in a folding and a rolling storage type. More particularly, the present disclosure relates to a deployable high-rigidity robot arm in a folding and a rolling storage type, the robot arm being configured such that a high storage efficiency and a high rigidity are capable of being simultaneously secured.

### BACKGROUND ART

A robot arm for a small system for diversifying tasks of a small mobile robot such as a robot cleaner, a drone, and so on is required.

Therefore, instead of a large-scale robot arm that causes problems in mobility and storage properties of a small mobile robot, a deployable robot arm in which a deployable mechanism is applied has been proposed. The deployable mechanism is a mechanism which is deployed only when a structure is used and then performs a task, is capable of storing the structure when the structure is not used, and is an effective mechanism for reducing space of an entire system.

mechanisms such as a deployable linkage mechanism, a foldable structure mechanism, a zipper mechanism, a rollable structure mechanism, and a pneumatically operated tube structure have been proposed as mechanisms for realizing a deployable robot arm. However, there are limitations as follows.

A rigidity or a strength of a structure of the deployable linkage mechanism may be weakened due to a sway of a joint connecting a link. That is, the rigidity of the structure and the storage efficiency are in a trade-off relationship. Therefore, when the number of links is increased, the storage efficiency is increased, but the overall structure becomes weaker. When the number of links is decreased, the storage efficiency is decreased, but the overall structure becomes stronger. Therefore, there is a limit to having a strong structure while having a high storage efficiency.

The foldable structure has an advantage that the foldable structure is folded flat through a folding line, so that the storage efficiency is high. However, the foldable structure has a disadvantage that a bending strength of an arm may be weakened by the folding line for storage in a longitudinal direction. Therefore, similar to the deployable linkage mechanism, the rigidity and the storage efficiency of the foldable structure are in a trade-off relationship, and there is a limit to having a strong structure while having a high storage efficiency.

The zipper mechanism is a mechanism in which a structure that was capable of being smoothly wound on a hub is changed to a solid shape through a structural coupling element such as a zipper, and the structure is deployed. At this time, a structural coupling portion is the most vulnerable portion, and the strength and the storage efficiency of the coupling portion have a trade-off relationship similar to that of the deployable linkage mechanism.

The rollable structure is also a mechanism that is wound on a hub, and there is an advantage that the rollable structure is simple to operate and has a high storage efficiency. However, in order to avoid structural destruction during a process of winding (rolling) on the hub, a structure with a limited thickness is only can be used, so that the rollable structure has a disadvantage that a high-rigidity arm is difficult to be realized.

In the rollable structure, a method of maximizing a cross-sectional change by dividing a finite thickness into multiple layers (panels) is used such that a change in a cross-sectional secondary moment within the limits is maximized. However, when the number of layers is increased, shear stress is accumulated due to a difference in curvature between layers during the process of winding on the hub, so that a buckling failure mode may easily occur. Furthermore, since the thickness per single layer must be reduced, there is a disadvantage that it is difficult to design a structure that has sufficient rigidity as desired.

Although there is an advantage that the pneumatically operated tube has a high storage efficiency, there is a disadvantage that the pneumatically operated tube cannot have a strength in a continuous deploy length since the strength is secured by additionally applying a higher pneumatic pressure in a maximally deployed state. In some research on pneumatically operated tubes, tube structure having rigidity even for an arbitrary shape in the middle of the structure has been implemented through a mechanism that controls a maximally deployed state of the tube. However, since a thin tube-type flexible material is used compared to a general linkage mechanism that uses a hard material, there is a problem that the rigidity and the strength are not relatively high.

In Korean Patent Application Publication No. 10-2016-0129699, a variable surface frame body and a variable volume space frame body using a telescopic arm are disclosed.

In the conventional technology, a telescopic arm which has a deployable scissor structure and which is capable of telescoping in a longitudinal direction is disclosed, but there is a disadvantage that the strength is structurally low.

As such, the development of a small arm that has a high storage efficiency sufficient to be stored in a small mobile robot and also has a high strength sufficient to be used as a robot arm while the small arm is deployed remains a difficult problem.

### SUMMARY

### Technical Problem

Accordingly, the present disclosure has been made keeping in mind the above problems occurring in the related art, and an objective of an embodiment of the present disclosure is to provide a deployable high-rigidity robot arm in a folding and rolling storage type, the robot arm being configured such that a high storage efficiency and a high rigidity are capable of being simultaneously secured.

### Technical Solution

According to an aspect of the present disclosure, there is provided a deployable high-rigidity robot arm in a folding and rolling storage type, the deployable high-rigidity robot arm including: a hub capable of being rotated forward or backward; a plurality of panels having a Slide and Fold Enabling (SaFE) structure that is capable of being wound or unwound on the hub; a shape-forming apparatus coupled to the plurality of panels and configured such that the plurality of panels is unwound from the hub and a bent structure is formed; shape-maintaining apparatus configured to maintain and extend the bent structure formed by the shape-forming apparatus, wherein the plurality of panels is configured to be telescoped by a rotation of the hub while the plurality of panels maintains the bent structure.

The deployable high-rigidity robot arm may further include a panel coupling member connecting the plurality of panels to each other such that the plurality of panels is capable of being slid and folded.

The panel coupling member may include: a plurality of slit forming units into which the plurality of panels is respectively inserted; and a joint unit to which the plurality of slit forming units is connected.

The plurality of slit forming units may be connected with each other in an integral manner toward a lateral direction.

The panel coupling member may be formed of a cloth material, and a plurality of insertion holes into which the plurality of panels is alternately inserted may be repeatedly formed in the panel coupling member.

The panel coupling member may be formed in a strap shape, and n panels may be woven with each other by n−1 straps. (where n may be an integer between two and ten.)

The panel coupling member may be formed in a single strap shape, and may be configured to woven the plurality of panels to each other.

The shape-forming apparatus may include: a cover portion configured to cover a region where the plurality of panels is unfolding, the cover portion having a guide portion which guides the plurality of panels and which is provided in the cover portion; and a shape-forming portion coupled to the cover portion such that the bent structure of the plurality of panels is formed.

The shape-maintaining apparatus may include a first shape-maintaining portion that is coupled to and fixed to a first end portion of the plurality of panels.

The shape-maintaining apparatus may further include a plurality of second shape-maintaining portions configured to be moved as the plurality of panels is telescoped.

The deployable high-rigidity robot arm may further include a plurality of distance adjusting apparatuses connecting a distance between the shape-forming apparatus and the shape-maintaining apparatus and a distance between the first shape-maintaining portion and the second shape-maintaining portions, the plurality of distance adjusting apparatuses being configured to adjust the distances.

The plurality of distance adjusting apparatuses may respectively include wire winding portions on which each wire is wound.

One of the wire winding portions in the plurality of distance adjusting apparatuses may be fixed to the shape-forming apparatus, and a first end of the wire may be fixed to one of the second shape-maintaining portions adjacent to the shape-forming apparatus.

One of the wire winding portion in the plurality of distance adjusting apparatuses may be fixed to one of the plurality of the second shape-maintaining portions, and a first end of the wire may be fixed to the other one of the adjacent second shape-maintaining portions.

One of the wire winding portion in the plurality of distance adjusting apparatuses may be fixed to one of the plurality of the second shape-maintaining portions, and a first end of the wire may be fixed to the first shape-maintaining portion.

According to another aspect of the present disclosure, there is provided a mobile robot including: the deployable high-rigidity robot arm in the folding and rolling storage type; a mobile platform capable of mounting the deployable high-rigidity robot arm in the folding and rolling storage type and capable of being moved, the mobile platform being capable of controlling a telescopic direction of the plurality of panels of the deployable high-rigidity robot arm; and a manipulator coupled to a first end portion of the plurality of panels of the deployable high-rigidity robot arm in the folding and rolling storage type, the manipulator being capable of performing an object control.

### Advantageous Effects

The deployable high-rigidity robot arm in the folding and rolling storage type according to the present disclosure has the following effects.

First, the storage efficiency may be increased through a double compression method in which compression through folding and compression through rolling are applied.

Second, unlike the trade-off relationship between the rigidity and the storage efficiency of the conventional folding method, the rigidity and the storage efficiency may be increased by using the folding compression method.

Third, even when the rolling compression method is used, the thickness limitations of the rolling compression method may be overcome, so that structural rigidity may be increased.

### DESCRIPTION OF DRAWINGS

FIG. 1A is a view illustrating a configuration of a deployable high-rigidity robot arm in a folding and rolling storage type according to an embodiment of the present disclosure, FIG. 1B is a view illustrating a component and an internal structure of a shape-forming apparatus of the deployable high-rigidity robot arm in the folding and rolling storage type according to an embodiment of the present disclosure, and FIG. 1C is a view illustrating an example in which panels are guided by the shape-forming apparatus illustrated in FIG. 1B.

FIG. 2 is a schematic view illustrating a main part of the deployable high-rigidity robot arm in the folding and rolling storage type according to an embodiment of the present disclosure.

FIG. 3A to FIG. 3C are schematic views illustrating a structure of a plurality of panels of the deployable high-rigidity robot arm in the folding and rolling storage type according to an embodiment of the present disclosure.

FIG. 4A to FIG. 4F and FIG. 5A to FIG. 5D are schematic views respectively illustrating examples of a panel coupling member connecting the plurality of panels of the deployable high-rigidity robot arm in the folding and rolling storage type according to an embodiment of the present disclosure.

FIG. 6A to FIG. 6D are schematic views illustrating another example of the panel coupling member connecting the plurality of panels of the deployable high-rigidity robot arm in the folding and rolling storage type according to an embodiment of the present disclosure.

FIG. 7A to FIG. 7D are views illustrating still another example of connecting two panels in the deployable high-rigidity robot arm in the folding and rolling storage type according to an embodiment of the present disclosure, and

FIG. 8A to FIG. 8E are schematic views illustrating an example in which panels are added in FIG. 7A to FIG. 7D and the panels are connected.

FIG. 9A to FIG. 9E are views illustrating yet another example of connecting two panels in the deployable high-rigidity robot arm in the folding and rolling storage type according to an embodiment of the present disclosure, and

FIG. 10A to FIG. 10E are schematic views illustrating an example in which panels are added in FIG. 9A to FIG. 9E and the panels are connected.

FIG. 11 is a schematic view illustrating a shape-maintaining portion and a distance adjusting apparatus of the deployable high-rigidity robot arm in the folding and rolling storage type according to an embodiment of the present disclosure.

FIG. 12A to FIG. 12C are schematic views illustrating an operation example of the deployable high-rigidity robot arm in the folding and rolling storage type according to an embodiment of the present disclosure.

FIG. 13 is a view illustrating a mobile robot in which the deployable high-rigidity robot arm in the folding and rolling storage type according to an embodiment of the present disclosure is mounted.

FIG. 14 is a view illustrating an operation example of the deployable high-rigidity robot arm in the folding and rolling storage type according to an embodiment of the present disclosure.

### DETAILED DESCRIPTION

The embodiments described below are provided so that those having ordinary skill in the art can easily understand the technical idea of the present disclosure, and thus the present disclosure is not limited thereto. In addition, the items represented in the attached drawings are the schematized drawings in order for easily describing the embodiments of the present disclosure and may be different from the forms actually implemented.

When any constituent element is referred to as being connected or contacted with other constituent elements, it should be understood that it may be directly connected or contacted with the other constituent elements but there may be the other constituent elements therebetween.

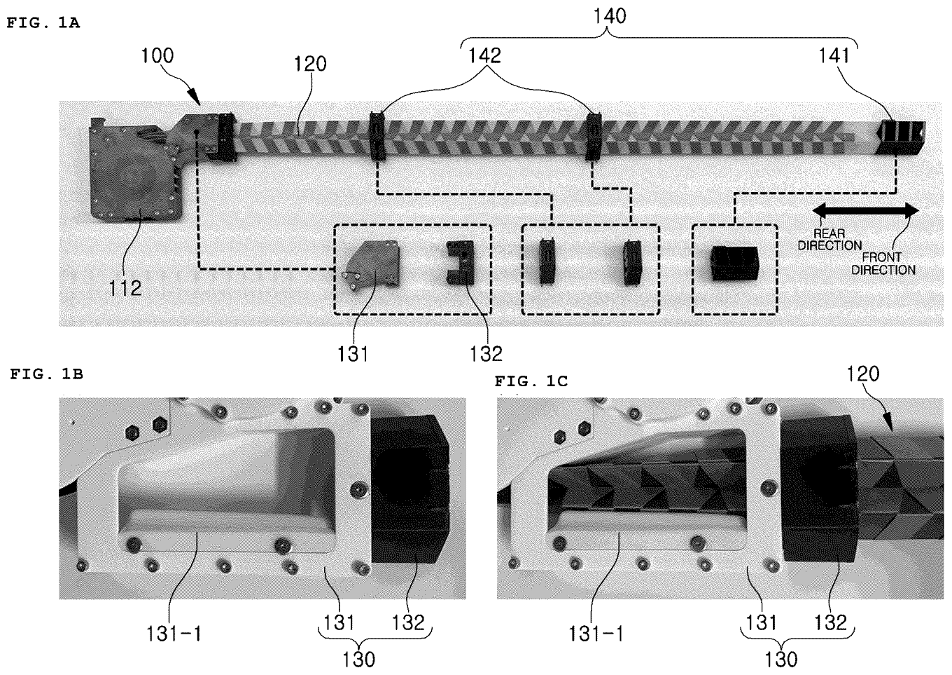

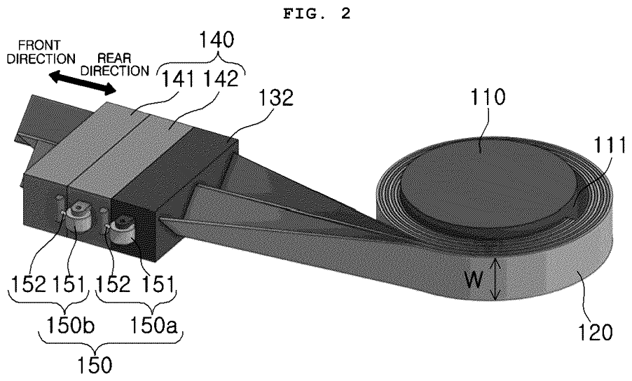

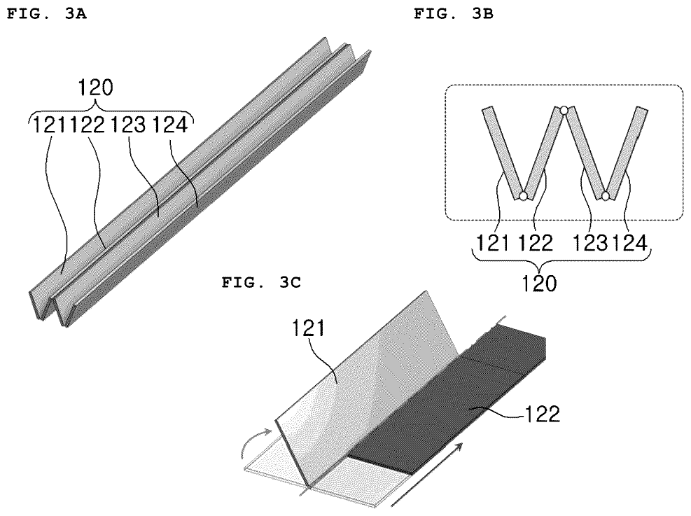

FIG. 1A is a view illustrating a configuration of a deployable high-rigidity robot arm in a folding and rolling storage type according to an embodiment of the present disclosure, FIG. 1B is a view illustrating a component and an internal structure of a shape-forming apparatus of the deployable high-rigidity robot arm in the folding and rolling storage type according to an embodiment of the present disclosure, FIG. 1C is a view illustrating an example in which panels are guided by the shape-forming apparatus illustrated in FIG. 1B, FIG. 2 is a schematic view illustrating a main part of the deployable high-rigidity robot arm in the folding and rolling storage type according to an embodiment of the present disclosure, and FIG. 3A to FIG. 3C are schematic views illustrating a structure of a plurality of panels of the deployable high-rigidity robot arm in the folding and rolling storage type according to an embodiment of the present disclosure.

Referring to FIG. 1A to FIG. 3C, a deployable high-rigidity robot arm 100 in a folding and rolling storage type according to an embodiment of the present disclosure includes a hub 110, a plurality of panels 120, and a shape-forming apparatus 130.

The hub 110 according to the present disclosure has a spiral line structure or a swirl structure in which a height of an outer side surface 111 is equal to or larger than a width W of the panels 120 and is smaller than a length of a radius of the hub 110, and is configured to be rotated forward or backward. An actuator configured to provide a rotational driving force may be provided inside the hub 110, or may be coupled to a central axis of the hub 110 from the outside.

The hub 110 is embedded in a hub housing 112. As the hub 110 is rotated forward or backward, the plurality of panels 120 is wound or unwound on the outer side surface 111 of the hub 110.

The panels 120 have a material that is capable of being wound on the outer side surface 111 of the hub 110 as the hub 110 is rotated backward.

In one specific example, the plurality of panels 120 may include a first panel 121, a second panel 122, a third panel 123, and a fourth panel 124.

The plurality of panels 120 each have a large length-to-width ratio and are connected to each other in a lateral direction perpendicular to a longitudinal direction by a panel coupling member, and is capable of being slid and folded.

According to the present disclosure, a double compression method using both folding and rolling realizes compression in a smaller space compared to a compression method using only rolling. When the same arm structure is wound on the same size hub ( [symbol] ), the following condition is required to be satisfied (when folding is performed n times in the process of applying the double compression method).

$$\text{?} \frac{\text{?}}{\text{?}}$$

$$\text{?} \text{indicates text missing or illegible when filed}$$

(Here, [symbol] =storage outer diameter when only the rolling compression method is used, [symbol] =storage height when only the rolling compression method is used, [symbol] =storage outer diameter when the double compression method is used, [symbol] =storage height when the double compression method is used)

Therefore, as described in the following equation, when the double compression method is applied, a storage volume when the double compression is applied is smaller than a storage volume when only the rolling compression method is applied.

$$\text{?}$$

$$\text{?} \text{indicates text missing or illegible when filed}$$

When one panel is wound on the hub and the panel is not destroyed, a sliding and folding structure manufactured by using the same shaped panels are not destroyed while being wound on the same shaped hub. In the sliding and folding structure according to the present disclosure, there is no limitation on an overall thickness of an arm structure since the number of panels that can be increased is not limited.

Therefore, by increasing the number of panels and applying a design that has a cross-sectional shape while being deployed, the design having various rigidity and various strength may be easily realized.

The shape-forming apparatus 130 according to the present disclosure includes a cover portion 131 and a shape-forming portion 132.

In the cover portion 131, a guide portion 131-1 that guides the plurality of panels 120 to be unfolded is coupled to an inner first side of the cover portion 131, and a space in which the plurality of panels 120 folded by being wound on the hub 110 is guided is formed, so that the plurality of panels 120 is capable of being guided such that the plurality of panels 120 in a folded state is unfolded or the plurality of panels 120 in an unfolded state is folded and wound on the hub 110.

The cover portion 131 covers a shape deformation portion where the plurality of panels 120 that folded by being wound on the hub 110 is unfolded.

The shape-forming portion 132 is coupled to a front end portion of the cover portion 131, and is configured such that the plurality of panels 120 is unfolded and a bent structure is formed. Here, a direction in which a length of the panels 120 extends away from the hub 110 is a front direction, and a direction in which the length of the panels 120 is reduced is a rear direction.

In the bent structure of the plurality of panels 120, the plurality of panels 120 is formed in a zigzag shape, a fan shape, or the bent structure in a vertical cross-section in the longitudinal direction of the plurality of panels 120.

Accordingly, the shape-forming apparatus 130 is coupled to the plurality of panels 120 such that the plurality of panels 120 is unwound from the hub 110 and then the plurality of panels 120 forms the bent structure.

A shape-maintaining apparatus 140 includes a first shape-maintaining portion 141, and may further include a plurality of second shape-maintaining portions 142.

The first shape-maintaining portion 141 is coupled to and fixed to a first end portion of the plurality of panels 120.

As the plurality of panels 120 telescopes, the second shape-maintaining portion 142 is coupled to a portion of the plurality of panels 120 in the longitudinal direction and is moved, and may be provided with the plurality of second shape-maintaining portions 142.

In the shape-maintaining apparatus 140 as described above, the bent structure of the plurality of panels 120 formed by the shape-forming apparatus 130 extends and is maintained.

In addition, when the second shape-maintaining portion 142 is included, a distance adjusting apparatus 150 may be used.

The distance adjusting apparatus 150 comprises a wire winding portion 151 on which a wire 152 is wound, and a plurality of adjusting apparatuses 150 may be used.

The wire winding portion 151 of one of the plurality of distance adjusting apparatuses 150 is fixed to the shape-forming portion 132 of the shape-forming apparatus 130, and a first end of the wire 152 is fixed to the second shape-maintaining portion 142 disposed adjacent to the shape-forming portion 132.

The wire winding portion 151 of the other one of the plurality of distance adjusting apparatuses 150 is fixed to the second shape-maintaining portion 142, and the first end of the wire 152 is fixed to the first shape-maintaining portion 141.

The plurality of distance adjusting apparatuses 150 is configured to connect a distance between the shape-forming apparatus 130 and the shape-maintaining apparatus 140. That is, the plurality of distance adjusting apparatuses 150 is configured to connect a distance between the shape-forming portion 132 of the shape-forming apparatus 130 and the second shape-maintaining portion 142 of the shape-maintaining apparatus 140, and to connect a distance between the first shape-maintaining portion 141 and the second shape-maintaining portion 142 that are included in the shape-maintaining apparatus 140, so that the plurality of distance adjusting apparatuses 150 adjust the distances.

As illustrated in FIG. 1A to FIG. 1C, when the plurality of second shape-maintaining portions 142 is mounted, one wire winding portion 151 in the plurality of distance adjusting apparatuses 150 may be fixed to the one of the second shape-maintaining portions 142 in close contact with the shape-forming apparatus 130, and the first end of the wire 152 may be fixed to the other one of the second shape-maintaining portions 142 disposed adjacent to the one of the second shape-maintaining portions 142.

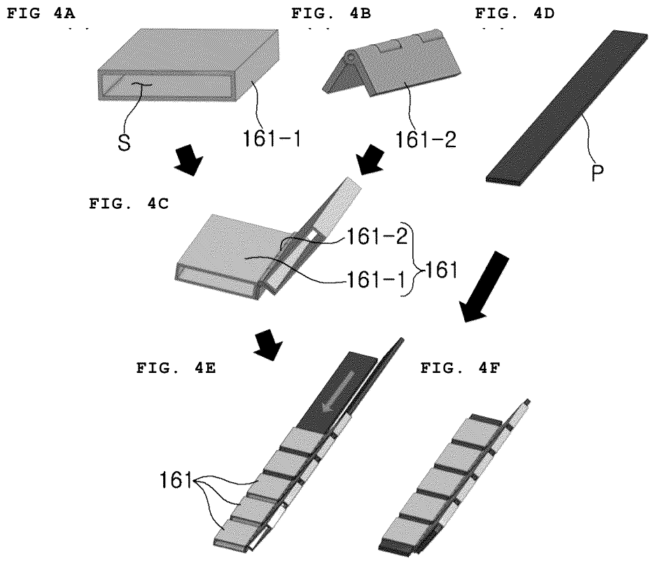

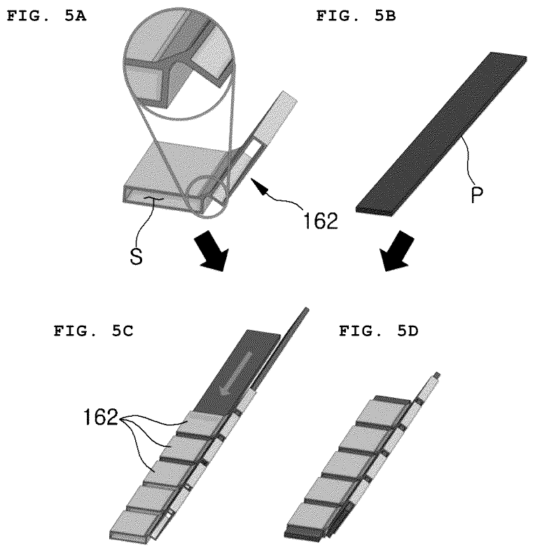

FIG. 4A to FIG. 4F and FIG. 5A to FIG. 5D are schematic views respectively illustrating examples of a panel coupling member connecting the plurality of panels of the deployable high-rigidity robot arm in the folding and rolling storage type according to an embodiment of the present disclosure.

Referring to FIG. 4A to FIG. 5D together with FIG. 1A to FIG. 3C, the deployable high-rigidity robot arm 100 in the folding and rolling type according to an embodiment of the present disclosure includes a panel coupling member capable of connecting the plurality of panels 120 to each other such that the plurality of panels 120 is capable of being slid and folded. The plurality of panels 120 is coupled by the panel coupling member, and is wound on or unwound from the hub 110.

In one specific example, the panel coupling member 161 includes a slit forming unit 161-1 and a joint unit 161-2.

A slit S where the panel penetrates therethrough and is inserted thereinto is formed inside the slit forming unit 161-1, and one panel P is inserted into the slit S.

The joint unit 161-2 connects a plurality of slit forming units 161-1 to each other in the lateral direction, and is configured such that the plurality of slit forming units 161-1 is capable of being rotated. The joint unit 161-2 is configured such that the plurality of panels 120 is capable of being folded.

Accordingly, in the panel coupling member 161, the plurality of panels 120 is slidably moved by the slit forming unit 161-1, and is folded by the joint unit 161-2.

The plurality of panel coupling members 161 may be continuously coupled along the longitudinal direction of one panel P.

In FIG. 5A, in a panel coupling member 162 according to another example, corner portions of the plurality of slit forming units in which each slit S is formed are connected to each other in an integral manner in the lateral direction and is capable of being folded, and one panel P is inserted into the slit S.

The plurality of panel coupling members 162 according to another example may be continuously coupled to the panels 120 along the longitudinal direction of the panels 120.

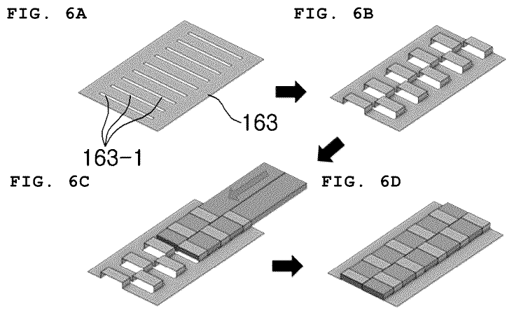

FIG. 6A to FIG. 6D are schematic views illustrating another example of the panel coupling member connecting the plurality of panels of the deployable high-rigidity robot arm in the folding and rolling storage type according to an embodiment of the present disclosure.

Referring to FIG. 6A to FIG. 6D together with FIG. 1A to FIG. 3C, in a deployable high-rigidity robot arm 100 in the folding and rolling storage type according to an embodiment of the present disclosure, a panel coupling member 163 according to still another example is formed of a cloth material, and a plurality of insertion holes 163-1 into which the plurality of panels 120 is alternately inserted is repeatedly formed in the panel coupling member 163.

As illustrated in FIG. 6C, the plurality of insertion holes 163-1 is spaced apart from each other, and the plurality of adjacent panels 120 is alternately inserted into the plurality of insertion holes 163-1.

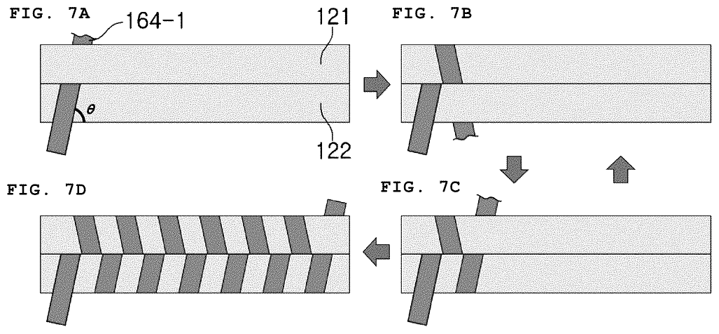

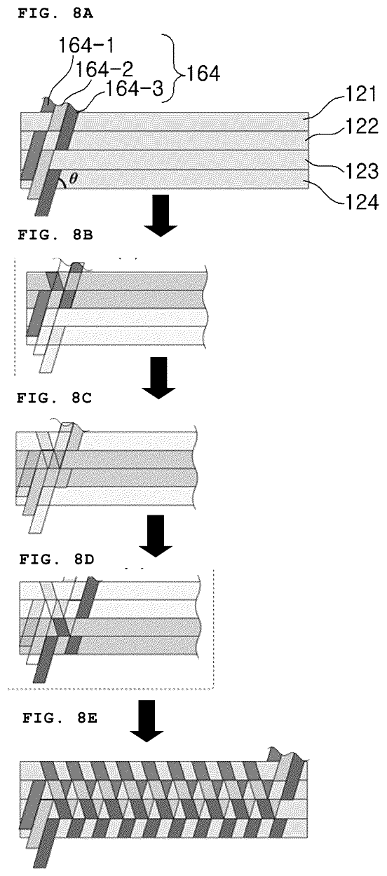

FIG. 7A to FIG. 7D are views illustrating still another example of connecting two panels in the deployable high-rigidity robot arm in the folding and rolling storage type according to an embodiment of the present disclosure, and FIG. 8A to FIG. 8E are schematic views illustrating an example in which panels are added in FIG. 7A to FIG. 7D and the panels are connected.

Referring to FIG. 7A to FIG. 7D and FIG. 8A to FIG. 8E together with FIG. 1A to FIG. 3C, a panel coupling member 164 according to still another example is formed in a strap shape, and n panels may be connected with n−1 connecting straps (where n is an integer between two and ten).

For example, two panels, that is, the first panel 121 and the second panel 122 adjacent to the first panel 121, may be woven with each other by a first connection strap 164-1. After the first connecting strap 164-1 is wound on the first panel 121 while the first connecting strap 164-1 is inclined by a predetermined angle θ, the first connecting strap 164-1 is inclined and wound on the adjacent second panel 122, and the same process may be repeated.

The panels may be added and woven together. For example, the third panel 123 and the fourth panel 124 may be woven with each other with the first panel 121 and the second panel 122. The first panel 121 positioned at an upper side among the plurality of panels 120 and the second panel 122 adjacent to the first panel 121 are woven with each other by the first connection strap 164-1. The first connection strap 164-1 to a third connection strap 164-3 are disposed on n panels 120 in a state in which the first connection strap 164-1 to the third connection strap 164-3 are inclined by a predetermined angle θ. That is, after the first connection strap 164-1 is inclined to the first panel 121 and is wound on the first panel 121, the first connection strap 164-1 is inclined to the second panel 122 and is wound on the second panel 122 disposed adjacent to the first panel 121. After the first connection strap 164-1 is inclined and wound from a lower portion of the second panel 122 to an upper portion of the second panel 122, the first connection strap 164-1 is wound on the first panel 121 again, and the process is repeated. Next, after the second connection strap 164-2 is inclined to the second panel 122 and is wound on the second panel 122, the second connection strap 164-2 is inclined to the third panel 123 and is wound from a lower portion of the third panel 123 to an upper portion of the third panel 123 disposed adjacent to the second panel 122. After the second connection strap 164-2 is inclined and wound on the third panel 123, the second connection strap 164-2 is wound on the second panel 122 again, and the process is repeated. Next, after the third connection strap 164-3 is inclined to the third panel 123 and is wound on the third panel 123, the third connection strap 164-3 is inclined to the fourth panel 124 and is wound from a lower portion of the fourth panel 124 to the upper portion of the fourth panel 124 disposed adjacent to the third panel 123. After the third connection strap 164-3 is inclined and wound on the fourth panel 124, the third connection strap 164-3 is wound on the third panel 123 again, and the process is repeated.

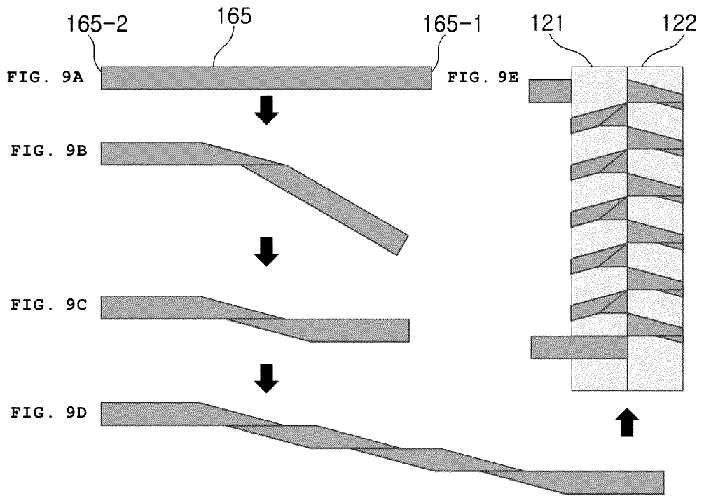

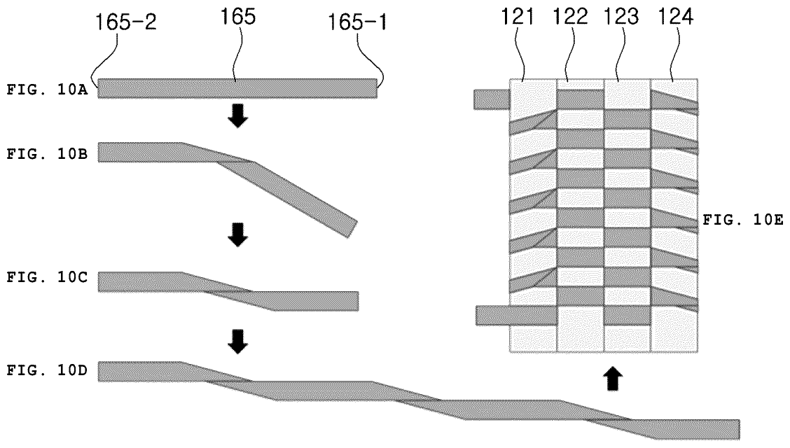

FIG. 9A to FIG. 9E are views illustrating yet another example of connecting two panels in the deployable high-rigidity robot arm in the folding and rolling storage type according to an embodiment of the present disclosure, and FIG. 10A to FIG. 10E are schematic views illustrating an example in which panels are added in FIG. 9A to FIG. 9E and the panels are connected.

Referring to FIG. 9A to FIG. 9E and FIG. 10A to FIG. 10E together with FIG. 1A to FIG. 3C, a panel coupling member 165 according to yet another example is formed a strap shape, and has a structure in which the plurality of panels 120 is woven with each other by a single connection strap.

For example, two panels, that is, the first panel 121 and the second panel 122 adjacent to the first panel 121, may be woven with each other by one panel coupling member 165.

In yet another example, in a state in which the panel coupling member 165 is in a straight line state, a portion of the panel coupling member 165 adjacent to a first end portion 165-1 is inclinedly folded, and the first end portion 165-1 is folded parallel to a second end portion 165-2. After the process described above is repeatedly performed such that the panel coupling member 165 is folded at intervals, and the panel coupling member 165 is alternately wound on the panels 120.

In addition, the panels may be added and woven together. For example, the third panel 123 and the fourth panel 124 may be woven with each other with the first panel 121 and the second panel 122.

That is, in the panel coupling member 165 according to yet another example, after the first end portion 165-1 passes through a lower side of the first panel 121 and then passes through an upper side of the second panel 122, the panel coupling member 165 passes through a lower side of the third panel 123 and passes through an upper side of the fourth panel 124, and then the panel coupling member 165 passes through an upper side of the third panel 123 again.

A region wound on the first panel 121 to the fourth panel 124 is moved in a first direction by a width of the panel coupling member 165, and the panel coupling member 165 is alternately wound on the first panel 121 to the fourth panel 124, so that the first panel 121 to the fourth panel 124 are woven with each other.

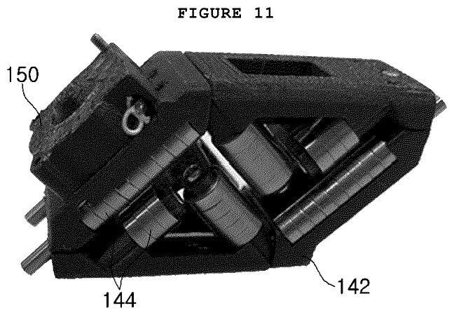

FIG. 11 is a schematic view illustrating a shape-maintaining portion and a distance adjusting apparatus of the deployable high-rigidity robot arm in the folding and rolling storage type according to an embodiment of the present disclosure.

Referring to FIG. 11 together with FIG. 1A to FIG. 3C, the distance adjusting apparatus 150 is coupled to the second shape-maintaining portion 142.

In the second shape-maintaining portion 142, two rollers 144 are formed as a pair such that two rollers 144 are is in close contact with each surface of the plurality of panels 120, and a plurality of roller pairs are provided in a zigzag shape in an inner space of the second shape-maintaining portion 142. In addition, the plurality of roller pairs of the second shape-maintaining portion 142 guides the plurality of panels 120 respectively such that the bent structure is formed.

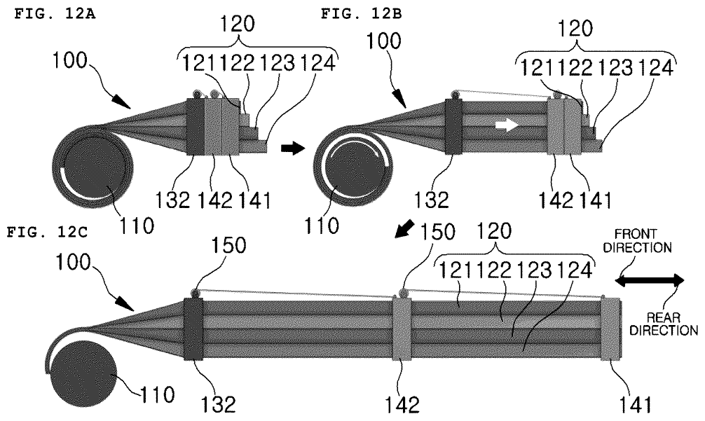

FIG. 12A to FIG. 12C are schematic views illustrating an operation example of the deployable high-rigidity robot arm in the folding and rolling storage type according to an embodiment of the present disclosure.

In describing an operational relationship of the deployable high-rigidity robot arm 100 in the folding and rolling storage type according to an embodiment of the present disclosure with reference to FIG. 12A to FIG. 12C together with FIG. 1A to FIG. 3C, the plurality of panels 120 is folded and wound on the outer side surface 111 of the hub 110.

When the hub 110 is rotated in a clockwise direction, the plurality of panels 120 is released from the hub 110 and extends in the front direction.

At this time, the plurality of panels 120 is coupled to the shape-forming apparatus 130 and the shape-maintaining apparatus 140. The plurality of panels 120 is unfolded at a shape deformation section between the hub 110 and the shape-forming apparatus 130, and is guided by the guide portion 131-1 of the shape-forming apparatus 130, so that the bent structure is formed at the shape-forming portion 132.

The plurality of panels 120 extends from the shape-forming portion 132 of the shape-forming apparatus 130, and the bent structure is maintained by the second shape-maintaining portion 142 and the first shape-maintaining portion 141 of the shape-maintaining apparatus 140, so that the plurality of panels 120 extends and is slidably moved.

At this time, the wire 152 of one of the distance adjusting apparatus 150 adjusts the distance between the shape-forming portion 132 and the second shape-maintaining portion 142, and the wire 152 of the other one of the distance adjusting apparatus 150 adjusts the distance between the second shape-maintaining portion 142 and the first shape-maintaining portion 141.

Each end portion of the first panel 121, the second panel 122, the third panel 123, and the fourth panel 124 has a stepped structure when the hub 110 starts to rotate. When the rotation of the hub 110 is completed, the first panel 121, the second panel 122, the third panel 123, and the fourth panel 124 are slidably moved, and each position of the end portions of the first panel 121, the second panel 122, the third panel 123, and the fourth panel 124 becomes the same.

Meanwhile, when the hub 110 is rotated in a counter-clockwise direction, the plurality of panels 120 is wound on the hub 110, and the length of the plurality of panels 120 is reduced rearward. In addition, the distance between the shape-forming apparatus 130 and the shape-maintaining apparatus 140 is reduced, and the shape-maintaining apparatus 140 is adjacent to the shape-forming apparatus 130 coupled to the hub 110.

At this time, the plurality of panels 120 is folding between the hub 110 and the shape-forming apparatus 130, and is wound on the outer side surface 111 of the hub 110.

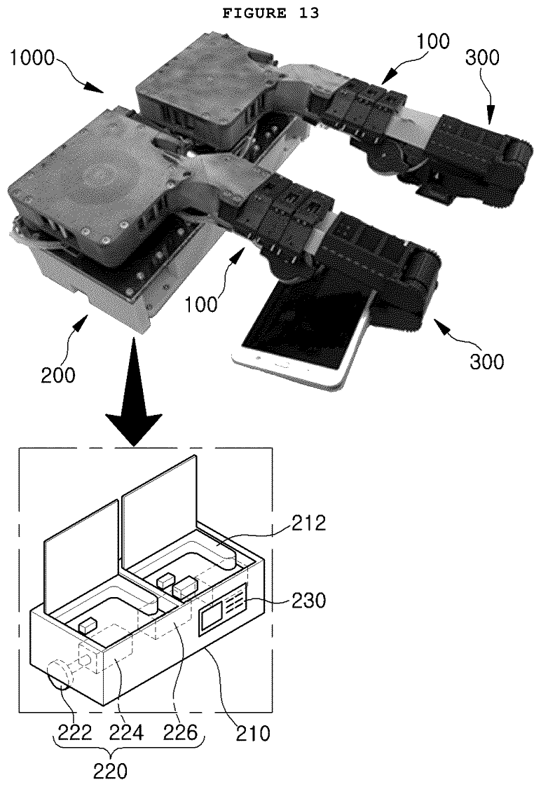

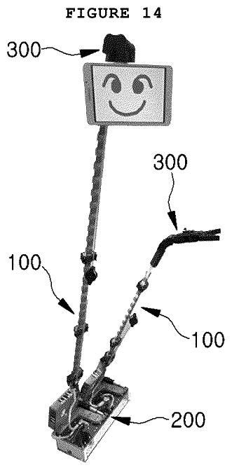

FIG. 13 is a view illustrating a mobile robot in which the deployable high-rigidity robot arm in the folding and rolling storage type according to an embodiment of the present disclosure is mounted, and FIG. 14 is a view illustrating an operation example of the deployable high-rigidity robot arm in the folding and rolling storage type according to an embodiment of the present disclosure.

Referring to FIG. 13 and FIG. 14 together with FIG. 1A to FIG. 12C, a mobile robot 1000 according to an embodiment of the present disclosure includes the deployable high-rigidity robot arm 100 in the folding and rolling storage type, a mobile platform 200, and a manipulator 300.

In one specific example, it is preferable that at least one deployable high-rigidity robot arm 100 in the folding and rolling storage type is mounted on an upper surface of the mobile platform 200.

The mobile platform 200 includes a mobile platform body 210, a sensor module, a power module 220, and a control module 230.

A rotation means 212 capable of being rotated in the vertical direction with respect to the ground is provided on an upper surface of the mobile platform body 210, and is configured such that the deployable high-rigidity robot arm 100 is capable of being rotated upward with respect to the ground.

The sensor module is configured to detect an external terrain and a distance between the mobile platform 200 and an external object so as to prevent collision.

The power module 220 includes a wheel 222 capable of being rotated with respect to the ground, a motor 224 configured to rotate the wheel 222, and a battery 226 configured to supply an entire operating power. In addition, a roller configured to be rotated together with the wheel 222 with respect to the ground may be provided.

The power module 220 configured to provide a driving force and a work driving force to the mobile platform 200.

The control module 230 is configured such that a user is capable of input an operation control to the control module 230, and is electrically connected to the deployable high-rigidity robot arm 100 in the folding and rolling storage type, the mobile platform 200, and the manipulator 300 so as to control the deployable high-rigidity robot arm 100 in the folding and rolling storage type, the mobile platform 200, and the manipulator 300 according to the input.

The control module 230 includes a microcontroller configured to perform an operation, and includes a storage device such as a memory that stores data.

In addition, the mobile robot 1000 includes a communication module, and is capable of transmitting and receiving input data through a user's wired or wireless terminal. Data transmitted and received through the communication module is transmitted to the control module 230 and to the user's wired or wireless terminal.

The manipulator 300 is coupled to the first end portion of the plurality of panels 120 of the deployable high-rigidity robot arm 100 in the folding and rolling storage type, and is electrically connected to the control module 230 such that the manipulator 300 is capable of performing an object control. Here, the object control refers to moving or manipulating a target object, and a monitor other than a gripper is capable of being manipulated. In some cases, a camera is capable of being manipulated, and devices or objects other than the camera are capable of being manipulated. That is, in the present disclosure, the object control refers to controlling not only a positional movement of the target object but also a manipulation of the object to perform a function of the object, and is not limited to a specific object or a specific function.

In the mobile robot 1000 according to an embodiment of the present disclosure, the hub housing 112 of the deployable high-rigidity robot arm 100 in the folding and rolling storage type is coupled to a rotation means 212 provided on the upper surface of the mobile platform body 210, so that the mobile robot 1000 is capable of being rotated in the vertical direction with respect to the ground and the operation of the mobile robot 1000 is controlled by the control module 230.

In describing the operational relationship of the mobile robot 1000 according to an embodiment of the present disclosure, the user controls the mobile robot 1000 such that the mobile robot 1000 is moved to an object that performs a work order.

When the mobile robot 1000 holds an object positioned at a height range in which the mobile robot 1000 is capable of holding the object by using the manipulator 300, the rotation means 212 is rotated such that the deployable high-rigidity robot arm 100 in the folding and rolling storage type coupled to the rotation means 212 is rotated in the vertical direction with respect to the ground.

As described above, the length of the deployable high-rigidity robot arm 100 extends such that the manipulator 300 coupled to the deployable high-rigidity robot arm 100 in the folding and rolling storage type moves toward the object.

By operating the hub 110, the plurality of panels 120 extends, so that the manipulator 300 approaches the object and holds the object in order to perform the object control. Here, the manipulator 300 may turn on and may fix an object such as a display pad.

In order for the manipulator 300 to move an object, the length of the deployable high-rigidity robot arm 100 in the folding and rolling storage type is reduced, and the object is moved to another position and the holding of the object is released.

Therefore, in the deployable high-rigidity robot arm in the folding and rolling storage type according to the present disclosure, the storage efficiency may be increased through the double compression method in which compression through through rolling are applied. folding and compression Furthermore, unlike the trade-off relationship between the rigidity and the storage efficiency of the conventional folding method, the rigidity and the storage efficiency may be increased by using the folding compression method. In addition, even when the rolling compression method is used, the thickness limitations of the rolling compression method may be overcome, so that structural rigidity may be increased.

It will be understood by those skilled in the art that the present disclosure can be embodied in other specific forms without changing the technical idea or essential characteristics of the present disclosure. Therefore, it should be noted that the above-described embodiments are merely embodiments selected and presented in order to help the understanding of those skilled in the art, so that the technical spirit of the present disclosure is not necessarily limited only to the presented embodiments, and various alterations, additions, modifications and other equivalent embodiments may be made without departing from the technical spirit of the present disclosure.

### Industrial Applicability

Since a conventional folding compression method and a conventional rolling compression method have different characteristics, it was difficult to integrate and use the two methods. Therefore, when one of the two compression methods was used, there was a trade-off relationship between the rigidity and the storage efficiency.

According to the present disclosure, by applying a joint portion element that can be used by integrating the folding compression method and the rolling compression method, a double compression method through folding and rolling may be realized, thereby increasing the rigidity and the storage efficiency.

1. A deployable high-rigidity robot arm in a folding and rolling storage type, the deployable high-rigidity robot arm comprising:
a hub capable of being rotated forward or backward;
a plurality of panels having a sliding and folding structure that is capable of being wound or unwound on the hub;
a shape-forming apparatus coupled to the plurality of panels and configured such that the plurality of panels is unwound from the hub and a bent structure is formed; and
a shape-maintaining apparatus configured to maintain and extend the bent structure formed by the shape-forming apparatus,
wherein the plurality of panels is configured to be telescoped by a rotation of the hub while the plurality of panels maintains the bent structure.

2. The deployable high-rigidity robot arm of claim 1, further comprising a panel coupling member connecting the plurality of panels to each other such that the plurality of panels is capable of being slid and folded.

3. The deployable high-rigidity robot arm of claim 2, wherein the panel coupling member comprises:
a plurality of slit forming units into which the plurality of panels is respectively inserted; and
a joint unit to which the plurality of slit forming units is connected.

4. The deployable high-rigidity robot arm of claim 3, wherein the plurality of slit forming units is connected with each other in an integral manner toward a lateral direction.

5. The deployable high-rigidity robot arm of claim 2, wherein the panel coupling member is formed of a cloth material, and a plurality of insertion holes into which the plurality of panels is alternately inserted is repeatedly formed in the panel coupling member.

6. The deployable high-rigidity robot arm of claim 2, wherein the panel coupling member is formed in a strap shape, and n panels are woven with each other by n−1 straps.

7. The deployable high-rigidity robot arm of claim 2, wherein the panel coupling member is formed in a single strap shape, and is configured to woven the plurality of panels to each other.

8. The deployable high-rigidity robot arm of claim 1, wherein the shape-forming apparatus comprises:
a cover portion configured to cover a region where the plurality of panels is unfolding, the cover portion having a guide portion which guides the plurality of panels and which is provided in the cover portion; and
a shape-forming portion coupled to the cover portion such that the bent structure of the plurality of panels is formed.

9. The deployable high-rigidity robot arm of claim 1, wherein the shape-maintaining apparatus comprises a first shape-maintaining portion that is coupled to and fixed to a first end portion of the plurality of panels.

10. The deployable high-rigidity robot arm of claim 9, wherein the shape-maintaining apparatus further comprises a plurality of second shape-maintaining portions configured to be moved as the plurality of panels is telescoped.

11. The deployable high-rigidity robot arm of claim 10, further comprising a plurality of distance adjusting apparatuses connecting a distance between the shape-forming apparatus and the shape-maintaining apparatus and a distance between the first shape-maintaining portion and the second shape-maintaining portions, the plurality of distance adjusting apparatuses being configured to adjust the distances.

12. The deployable high-rigidity robot arm of claim 11, wherein the plurality of distance adjusting apparatuses respectively comprises wire winding portions on which each wire is wound.

13. The deployable high-rigidity robot arm of claim 12, wherein one of the wire winding portions in the plurality of distance adjusting apparatuses is fixed to the shape-forming apparatus, and a first end of the wire is fixed to one of the second shape-maintaining portions adjacent to the shape-forming apparatus.

14. The deployable high-rigidity robot arm of claim 12, wherein one of the wire winding portion in the plurality of distance adjusting apparatuses is fixed to one of the plurality of the second shape-maintaining portions, and a first end of the wire is fixed to the other one of the adjacent second shape-maintaining portions.

15. The deployable high-rigidity robot arm of claim 12, wherein one of the wire winding portion in the plurality of distance adjusting apparatuses is fixed to one of the plurality of the second shape-maintaining portions, and a first end of the wire is fixed to the first shape-maintaining portion.

16. A mobile robot comprising:
the deployable high-rigidity robot arm in the folding and rolling storage type according to claim 1;
a mobile platform capable of mounting the deployable high-rigidity robot arm in the folding and rolling storage type and capable of being moved, the mobile platform being capable of controlling a telescopic direction of the plurality of panels of the deployable high-rigidity robot arm; and
a manipulator coupled to a first end portion of the plurality of panels of the deployable high-rigidity robot arm in the folding and rolling storage type, the manipulator being capable of performing an object control.
